(19) United States
(12) Patent Application Publication
(10) Pub. No.: US 2007/0226094 A1
(43) Pub. Date: Sep. 27, 2007

(54) System and method for using intellectual property holding companies to validate the market value of intellectual property and provide investment opportunities

(76) Inventors: James E. Malackowski, Chicago, IL (US); Robert Block, Chicago, IL (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/292,728

(22) Filed: Dec. 1, 2005

Related U.S. Application Data
(60) Provisional application No. 60/632,156, filed on Dec. 1, 2004.

(51) Int. Cl. G06Q 40/00

(52) U.S. Cl. 705/35

(57) ABSTRACT

Methods are disclosed for using computers, computer programs, algorithms and computer networks and communications hardware and protocols to calculate and optimize cash flows and capital structures in financing structures relating to intellectual property holding companies.

### CROSS-REFERENCE TO RELATED APPLICATIONS

This application claims the benefit of U.S. Provisional Patent Application Ser. No. 60/632,156, filed on Dec. 1, 2004, the entire contents of which are hereby incorporated herein by reference.

### BACKGROUND OF THE INVENTION

1. Field of the Invention

The present invention in various embodiments relates to the use of computers, computer programs and computer algorithms, as well as computer communication devices and protocols, to optimize and implement financing strategies and structures related to intellectual property holding companies.

2. Description of the Related Art

In today's knowledge economy, intellectual property (IP) is the most important driver of growth and long term profitability. In recent years, corporations have increasingly recognized the importance of their IP and have begun to actively manage it, both in its own right, and as an integral component of the larger corporate strategy. Many companies have formed distinct corporate entities, referred to as IP holding companies (“IPHCs” or “HCs”) whose mandate is to effectively manage corporate IP, with a primary emphasis on patents and related know-how, but also encompassing trademarks, copyrights and other forms of intellectual property.

While some have used the platform to further corporate strategy and growth, many more have viewed these HCs as vehicles to reap state tax advantages.

### SUMMARY OF THE INVENTION

Some embodiments of the invention provide a method for financing an intellectual property holding comprising: transferring IP assets from an IP source entity to a separate IP holding company; transferring back to the IP source entity at least a portion of the ownership of the IP holding company; transferring at least one investment interest from the IP holding company to at least one 3rd party investor; and transferring capital from the at least one 3^{rd} party investor to the IP holding company.

In some embodiments of the invention, the IP holding company back licenses some or all of the IP assets to the IP source entity. In some embodiments, the IP holding company loans the capital to the IP source entity and the IP holding company receives an intercompany from the IP source entity in return.

In some embodiments the investment interest the 3^{rd} party investor receives is a preferred membership interest. In some embodiments the investment interest the 3^{rd} party investor receives is a preferred common interest. In some embodiments the investment interest the 3^{rd} party investor receives is a lender interest.

In some embodiments, more than one type of investment interest is issued to 3^{rd} party investors. Preferably, the different investment interests have different rights and/or obligations associated therewith. Generally, the different investment interests include a common interest and/or a preferred interest and/or a lender interest.

One aspect of the present invention relates to using computers, computer programs and computer algorithms, as well as computer communication devices and protocols, to optimize and implement financing strategies and structures.

Some embodiments of this invention comprise computer based tools, programs, algorithms and communications hardware and protocols which facilitate several business and financial objectives. For example, some embodiments will provide a method of holding, owning, managing and financing intellectual property including, but not limited to patents & related know-how, trademarks, customer lists, brands, trade secrets, etc.

Embodiments of the invention will also provide methods of validating IP valuation assumptions and inter-company IP license royalty assumptions. Some embodiments provide methods of increasing market valuation of a company by facilitating investment in value-driving IP. Embodiments of the invention can provide methods of improving liquidity, access to capital and pricing for borrowers. Embodiments of the invention can provide methods to enable Borrowers/IP Owners to maintain control over their IP. Embodiments of the invention can provide methods of hedging IP related illiquidity risks such as IP being found invalid or trying to borrow against intangible assets in a distressed scenario.

Embodiments of the invention can also provide methods of diversifying funding sources by accessing investors looking for relatively pure IP investment exposure (i.e., investment in companies focused on management of IP as their main business). Embodiments of the invention can provide methods to allow investors to share in growth and upside generated by IP and accruing to its owners. Embodiments of the invention can provide methods of protecting IPHC tax benefits by building substantive features into the design of the IPHC, thereby demonstrating the bona fide nature of the entity. Embodiments of the invention can provide methods of increasing reporting transparency by segregating and tracking previously underreported intellectual property, and by validating the reported values via third party appraisals and arm's length financings.

Embodiments of the invention can also provide methods of motivating senior executives to maximize the value of corporate IP by granting partial ownership and/or options in the IPHC. Embodiments of the invention can provide methods of diversifying the IPHC capital structure to include debt, preferred (junior and senior) and common equity/membership interests in the ownership of the IPHC. Embodiments of the invention can provide methods of diversifying the IPHC capital structure to provide for accessing both private investors and public capital markets. Embodiments of the invention can also provide methods of determining a valuation of the IP held by the IPHC through trading of equity and residual interests in the IPHC.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a diagram that shows one aspect of the relationship between the IP source entity 100 and the IPHC 110.

FIG. 2 is a diagram representing one embodiment of the capitalization of the IPHC.

FIG. 3 diagrams one embodiment of the cash flows between the IP source entity 100, the IPHC 110, the lender, and the preferred members.

FIG. 4 is a diagram of one embodiment of the of the capitalization and cash flows between the IP source entity 100, the IPHC, the lender, the preferred members, and the common interest.

FIG. 5 is one embodiment of a computer system that is used in some embodiments of the invention.

### DETAILED DESCRIPTION OF THE PREFERRED EMBODIMENT

In the following description, for the purposes of explanation, numerous specific details are set forth in order to provide a thorough understanding of the present invention. It will be evident to one skilled in the art, however, that the exemplary embodiments may be practiced without these specific details. In other instances, structures and device are shown in diagram form in order to facilitate description of the exemplary embodiments.

Reference will now be made in detail to embodiments of the present invention, examples of which are illustrated in the accompanying drawings. Wherever possible, the same reference numbers will be used throughout the drawings to refer to the same or like parts.

Some embodiments of the present invention involve methods of optimizing corporate capital structure consistent with the goal of maximizing the value of IP. Some embodiments involve using computer based models to calculate anticipated cash flows of the corporate capital structure under various scenarios and stress assumptions, and to constrain such calculations with respect to borrower and investor requirements. Some embodiments of the invention are directed to the formation and structure of an intellectual property holding company 110 (“IPHC”). In some embodiments, the IPHC 110 is a limited liability corporation. The IPHC may be created using the intellectual property (“IP”) owned by an IP source entity 100. The IP source entity 100 may be any type of entity that owns rights in one or more IP assets. For example, IP source entity 100 may be a corporation, a partnership, an individual, etc.

Ownership of the one or more IP assets by the IP source entity 100 may be based on creation, for example where a person within the IP source entity 100 creates an invention and obtains a patent directed to the invention or creates an original work and obtains a copyright. Alternatively, ownership may be a result of an acquisition of an IP asset originally owned by another entity. Further, ownership may be based on an acquisition by licensing of an IP asset owned by another. Yet further, the ownership may be ownership in whole or in part. Ownership of an IP asset can include any type of ownership that confers the right to exercise one or more IP rights associated with the IP asset.

Examples of IP assets may include patents, copyrights, trade secrets, trademarks, etc. Patents entitle the owner to exclude others from practicing the invention covered by the claims in the patent. Another type of intellectual property is information described in writings and knowledge arising within a business which is: (a) not generally known by others; (b) retained in secret, and disclosed to others only under an obligation of confidentiality, and (d) confers some economic benefit on its holder (such IP assets are hereinafter referred to as “trade secrets” or “know how”). Copyrights are another form of IP that may be securitized. Copyrights provide authors with the right to control reproduction of their original intellectual creations, such as literary works, musical works, dramatic works, pictorial works, motion pictures, sound recordings and architectural works.

A characteristic of all such intellectual property assets is the right to license, lease, or otherwise convey rights to others to use or otherwise practice the useful art, in whole or in part, embodied in such intellectual properties (hereinafter referred to as “licensing”). The licensing of these rights to a third party may be made in return for some type of compensation, such as royalty payments. A further characteristic of intellectual property assets is the right to identify potential infringers of the intellectual property asset and to request or sue for payment of a reasonable royalty rate or other remuneration based on the infringing use.

IP rights can include any right associated with an IP asset. An IP right may be conferred by statute, case law, practice in the industry, inherent properties, etc. An IP right may further include the right to perform an action and/or prevent another party from performing an action. For example, patents entitle the owner to exclude others from importing, making, using, selling, or offering to sell the invention covered by the patent. Further, copyrights provide authors the right to control reproduction of their original intellectual creations, such as literary works, musical works, dramatic works, pictorial works, motion pictures, sound recordings and architectural works, along with the right to make derivative works.

Further, it is often possible to license IP rights arising from the same IP asset or group of IP assets to two or more entities simultaneously. For example, as stated above, a patent generally includes a right to exclude others from practicing the invention. Inherent in the right to exclude is the right to license particular entities to practice the invention, usually in return for compensation, such as licensing fees. Further, different types of licenses may be granted such as an exclusive license, a non-exclusive license, an exclusive license within a defined field of use, etc. Whenever a license to one entity is other than an exclusive license to all fields of use for the entire economic life of the underlying IP asset, residual rights in the IP asset are created and may be licensed to other entities. Thus, a residual portion of an IP asset includes a right under the IP asset that is less than all of the rights afforded by the IP asset.

Therefore, the IP source entity 100 may not be fully utilizing the IP rights afforded under one or more IP assets. For example, where the IP source entity 100 is a vehicle manufacturer that owns a patent directed to a method of spray painting, the vehicle manufacture may only be utilizing the patented method of spray painting as applied to vehicles. Accordingly, the only portion of the IP rights that the vehicle manufacturer needs to practice its trade is the right to spray paint vehicles under the patent, despite that the patented method may be useful for objects other than vehicles. In this situation, the unused portion of the IP rights is simply wasted in the sense that it may have economic value to others but is not being exploited.

This is the case when the patent rights owned by one party (e.g., IP source entity 100) are broader than what it needs to practice its trade. In the example provided above, the spray painting method being used by the vehicle manufacturer to spray paint vehicles may be broad enough to cover and would also work well for spray painting houses. In this example, the portion of the IP rights not being used by the vehicle manufacture may be referred to as a residual portion. The residual portion may not be utilized by the vehicle manufacturer because the manufacturer may have no interest in preventing others from using this method to spray paint houses. The IP right residual portion may include numerous residual portions delineated by field of use, term of use, geographic location of use, etc.

Further, a company may own IP assets that are non-core IP assets. That is, the subject matter of the IP assets may not be aligned with the focus of the company's business strategy. In these situations, the company may not currently be using any of the IP rights associated with the non-core IP assets.

The residual portion of the IP rights or the IP rights associated with non-core IP assets, although not valuable to the IP source entity 100 in its present business, may be valuable to another entity in a different business. To continue the example from above, a house painting entity may be interested in utilizing the residual portion of the spray painting IP asset. In particular, the house painting entity may desire to license one or more IP rights in the residual portion of the IP asset for painting houses. Further, there may be infringers of the residual portion of the IP asset. As such, it may be possible to obtain reasonable royalties or other redress based on the infringing use of residual rights by the infringers.

However, the IP source entity 100 may not possess resources or specialized knowledge required to capture a potential income that may be generated based on the residual portion of the IP rights or the non-core IP rights. For example, licensing revenue can only be generated if the IP source entity 100 is able to identify potential licensees. Identifying potential licensees may require in depth analysis of IP rights and markets where the IP rights may be of value. This type of analysis may require a diverse and specialized knowledge base.

Intellectual Property Holding Companies

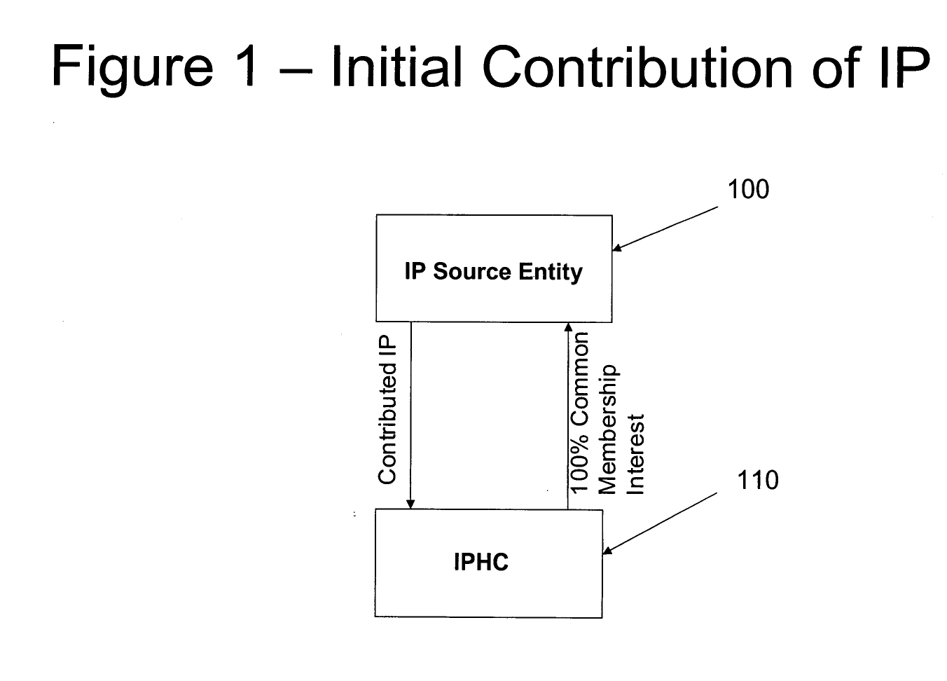

According to an exemplary embodiment, the IP source entity 100 may desire to create an entity dedicated to managing its IP, which may take the form of an IPHC 110. In some embodiments, the IP source entity 100 transfers IP rights to the IPHC 110 in return for an interest in the IPHC 110, as depicted in FIG. 1. In some embodiments, the interest in the IPHC 110 that the IP source entity 100 receives is in the form of stock. In some embodiments, the IP source entity 100 and/or related entities can obtain licenses from IPHC 110 for some or all of the rights to some or all of the IP in exchange for royalties or other compensation.

Preferably, the IPHC 110 is structured to comply with legal and procedural formalities in order to receive the hoped-for tax benefits, but also to realize the full strategic, competitive and financial benefits of an IPHC. By failing to appreciate the full possibilities created by a thoughtfully conceived and well managed IPHC, many companies are currently leaving tremendous value on the table in terms of foregone revenue growth opportunities, competitive advantage and risk reduction. Accordingly, the manner in which an IPHC 110 is structured may dictate the extent to which the IPHC benefits the IP source entity 100. Some embodiments of the invention provide methods of optimizing IPHC design to maximize potential for realizing benefits from creating/operating an IPHC. Some embodiments of the invention provide methods of creating both private and public market securities that enable investors to earn premium returns from and acquire relatively pure exposure to issuer IP. These securities may be sold to parties seeking investment interests in the IPHC 110. Some embodiments of the invention provide methods for allocating risk and benefits of IP ownership among various classes of investors in the IPHC. Some embodiments of the invention provide methods of valuing IP and associated royalties. In some embodiments, such valuation calculations apply standard discounted cash flow calculations unique to IP valuations and/or statistically based valuation methodologies.

From the IPHC/IP Owner's perspective, financing against its IP at the IPHC level can accomplish several objectives. The IPHC 110 may obtain value from the relevant intellectual property by entering into an active licensing program. As discussed above, in some embodiments the IPHC offers enhanced management and monetization of the IP, which may increase IP liquidity through royalties and other payments.

In some embodiments, the IPHC provides other forms of increased financial liquidity. For example, the IP's legal and functional separation from the IP source entity 100 may make it easier to perfect security interests in the IP. Preferably, this facilitates borrowing against the IP and the securitization of royalty streams from IP licenses. Furthermore, this may provide diversified funding by increasing access to capital sources seeking focused exposure to opportunities to invest in IP investment.

Some embodiments of the invention provide methods of integrating risk management tools and strategies into the design and financing of an IPHC. Several classes of corporate risk may be mitigated when IPHCs borrow or otherwise issue liabilities in arm's length, commercial transactions. These risks include: GAAP reporting risk; liquidity risk; and/or valuation risk (of IP itself as well as royalties associated therewith risk). Valuation risk can be reduced because financings based on contributed IP or royalties can validate transfer pricing claims. Liquidity risk can be mitigated by IP monetizations to the extent they collateralize or lock in borrowing power and hedge the risk of IP asset impairment or depreciation. Shareholder reporting risk may be managed through more transparent disclosure and reporting of the value of assets driving enterprise value. The risk that accounting practices will be judged inadequate or non-compliant with GAAP may also be reduced. In some embodiments, the invention includes the automatic calculation and dissemination of financial information via computers and computer networks and communication devices, which may also serve to mitigate financial reporting risks.

When properly organized and operated, some embodiments of the IPHC 110 may also confer tax benefits. In some embodiments the IP source entity 100 transfers intellectual property to IPHC 110 and then pays royalties to the IPHC 110 for rights to use the intellectual property in the course of its business. If the IP source entity 100 is domiciled in a high tax jurisdiction and the IPHC 110 is domiciled in a low tax jurisdiction, the net effect may be to reduce income in the high tax jurisdiction through the payment of fully deductible royalties and increase income in the low tax jurisdiction through receipt of such royalties. In addition, depending how cash earned at the IPHC 110 is returned to the IP source entity 100, certain other payments from the IP source entity 100 to the IPHC 110 may also be deductible

The future value of such tax reductions, discounted for the time value of money, may be referred to as having an ascertainable net present value (NPV). The NPV of future tax benefits for the IPHC 110 may run into the millions of dollars and could conceivably run into the hundreds of millions, or billions of dollars for an appropriately sized corporation. Users of the IPHC 110, such as the IP source entity 100, obtain many other benefits from this method of doing business, including administrative and operational efficiencies. However, IPHC 110 may be open to challenges on the basis that they lack substance and are effectively “sham” entities, organized solely for tax benefits. The risk of legal challenge by taxing authorities threatens NPV as well as the effective operation of IPHC 110.

By viewing these entities solely as state tax shelters, entities risk losing the very tax benefits they hope to achieve. In some embodiments, tax risk can be mitigated by management of the IPHC. Arm's length transactions with third parties, including, borrowings and other financing may reduce the risk of interference by taxing authorities. Further, the IPHC may actively engage in business with entities other than its own parent—including sales, purchases and licenses of IP, as well as financings against the IP and associated royalties. Moreover, in some embodiments of the invention, care is taken to avoid structuring cash distributions and receipts in a purely circular fashion. These and other measures may reduce tax risk because tax authorities, who may otherwise challenge the business purpose of the entity, can perceive the substantive, bona fide nature of the IPHC.

In some embodiments, the IPHC 110 will enhance valuation of the IP source entity 100 by making it easier for the market to perceive and value the contribution of its IP to growth and profitability. Advantageously, this may increase shareholder value, as the debt and equity markets' understanding of the value of IP to the IP source entity 100 may be incorporated into the pricing of the IP source entity's 100 debt and equity.

Still other embodiments provide methods for granting ownership rights in the IPHC 110 to motivate employee performance (e.g., senior executives). Preferably, this allows the IP source entity, as well as related entities, to formulate alternative compensation strategies. For example, options and shares of the equity of an IPHC can be used as part of the IP source entity's 100 compensation plan to incentivize key employees and executives. In some embodiments, granting ownership rights in the IPHC 110 incentivizes employees to work to maximize the value of the relevant IP.

In some embodiments the invention may also provide validation for the IP source entity's 100 business model by signaling the value of its IP. Furthermore, some embodiments of the invention may help focus attention and effort on the integration of IP into the larger corporate strategy and capital structure.

From the Lender/Issuer/Investor perspective, investing in IPHCs—whether as a debt lender, preferred lender junior or senior), equity lender, or other type of investor—can be attractive for several reasons. For example, formation of an IPHC allows investment in relatively pure IP risk, and such investments can generate incremental returns relative to more traditional investments in the same company. Investing in an IPHC also provides flexibility to optimize the investment structure to address strategic, operational, risk management, tax and accounting concerns for both the borrower/issuer and lender/investor while simultaneously optimizing returns and recognizing varying risk/return appetites of various classes of investor/lender. Investing in an IPHC also provides a secondary benefit to investors through the general corporate obligations of the IP source entity 100 to report and disclose incremental information about the company's IP and related royalties. Another advantage to IPHC investors is that the IP risk being assumed can be insured across a portfolio of investments thereby improving the risk/reward profile of an otherwise unconventional or non traditional asset class.

Corporate Structure

As mentioned above, the manner in which an IPHC 110 is structured may dictate the extent to which the IPHC 110 benefits the IP source entity 100. Preferably, the IPHC 110 is a wholly-owned subsidiary of the IP source entity 100, and, in some embodiments the IPHC 110 is a limited liability corporation. Preferably, the IPHC 110 seeks funding sources comprised of a senior credit facility, preferred membership interests and common membership interests. Preferably, the financing relies on the IPHC's 110 cash flows, including operating revenue derived from licensing and commercializing intellectual property to the IP source entity 100 and to third parties as well as distributions and interest received from the IP source entity 100 and third parties. Preferably, the proceeds will be used to fund the IPHC's 110 ongoing operations and/or distributed or loaned to the IP source entity 100.

Relationship between the IPHC and the IP Source Entity

FIG. 1 illustrates one embodiment of a relationship between the IP source entity 100 and the IPHC 110. Preferably, the IP source entity 100 transfers some or all of its IP rights to the IPHC 110 (the “Contributed IP”). The Contributed IP may include patents, trademarks, copyrights, customer lists and other intellectual property. Preferably, the IP source entity 100 receives 100% of the membership interests in IPHC 110 (the “Common Membership Interests”) as compensation. It is also possible that the IP source entity 100 receives less than 100% of the Common Membership Interest, for example, the IP source entity could receive 95% or 90 % of the Common Membership Interest. In an alternative embodiment, IPHC may already exist, having been formed earlier by IP source entity 100. In some embodiments, the IPHC 110 is intended to serve as the manager and legal owner of IP source entity's 100 IP.

The agreement between the IPHC 110 and the IP source entity 100 may comprise various terms appropriate for managing the above relationship. The following are examples of contractual terms that may be included in the agreement. They are provided as an example embodiment, and the invention should not be construed to require any or all of these provisions. Various combinations or additional terms may be used to manage the relationship between the IPHC 110 and the IP source entity 100.

Preferably, the IP source entity 100 conveys all right, title and interest in and to the Contributed IP to the IPHC 110. In some embodiments the IPHC's 110 organizational documents prohibit the IPHC from selling, pledging, assigning or otherwise transferring its interest in (a) the Contributed IP, (b) the Back-License Agreement (as hereinafter discussed), and (c) all 3^{rd} Party Licenses (as hereinafter discussed). However, some embodiments may provide that assignment shall be permitted if senior creditors or other investors require such transfer. In some embodiments, the IP source entity 100 conveys the rights to past damages relating to the Contributed IP to the IPHC 110. The rights to past damages associated with the Contributed IP may include the right to sue third parties for IP related damages in the IP source entity's 100 name.

In some embodiments, the IP source entity 100 makes representations and warranties regarding the contributed IP. For example, the IP source entity may represent that full disclosure regarding the IP has occurred. In one embodiment, the IP source entity 100 will disclose if the Contributed IP is or has been subject to any interference, cancellation or other protest proceeding or any other challenge to its validity or the patentability of the art reflected therein, in the United States or otherwise, or whether or not such proceedings have, to the best knowledge of IP source entity 100, been threatened. In some embodiments, the IP source entity 100 represents and warrants that it is the sole owner of the Contributed IP. This may include terms that each inventor of the inventions covered by the Contributed IP, other than the IP source entity 100, has assigned all their right, title and interest in the Contributed IP to the IP source entity 100 by a valid and enforceable assignment. In some embodiments the IP source entity 100 might also warrant that no other person has a lien, encumbrance or other interest in any of the patents or other IP other than the holders of existing licenses. The existing licenses, if any exist, may be specified in an exhibit attached to the relevant agreement. The IP source entity 100 may also agree to provide certified copies of recorded assignments of the Contributed IP.

The IP source entity 100 may agree to disclose any known or potential infringement of any Contributed IP by any third party to the best knowledge of the IP source entity 100. Another possible provision(s) is for the IP source entity 100 to warrant and represent that: the Contributed IP has been validly issued by the Commissioner of Patents and Trademarks of the United States or by similar authority in the jurisdiction of issuance; each inventor of the inventions covered by the Contributed IP was properly named as an inventor, and no other persons were so named; all fees, maintenance fees and filings required to be submitted to the United States Patent and Trademark Office (the “USPTO”) or similar office outside the United States have been made and all administrative obligations thereto have been satisfied. The IP source entity 100 may also warrant that it currently uses or plans to use some or all of the technology rights or other IP contained within the Contributed IP.

In some embodiments, the IP source entity 100 may covenant regarding the Contributed IP as follows:
IP source entity 100, at the reasonable request of the IPHC 110, and upon reasonable notice, shall furnish training and technical assistance services with respect to the Contributed IP to the IPHC 110 or to a third party designated by IPHC, provided however that such third party shall be one to whom the IPHC 110 has licensed the Contributed IP. Such training and technical assistance shall be limited to a [pre-defined number of] hours at no charge to the IPHC 110 or its assignees, and [pre-defined number of] hours billed to IPHC or its assignees at $[pre-defined amount] per hour and solely for the purpose of outlicensing or otherwise commercializing the Contributed IP (the “Training and Technical Assistance”). These terms in no way obligate the IP source entity 100 to participate in litigated enforcement proceedings.
The IP source entity 100 and the IPHC 110 will cooperate in the filing and execution of any and all documents necessary to effectuate the assignment to the IPHC 110 of the Contributed IP and rights to past damages, including filing of assignments or other transfer of title covenants with the USPTO or similar authority outside the US. The cost of recording assignments of the Contributed IP will be borne by IP source entity 100.
The IP source entity 100 will transfer all files and supporting documents reasonably relating to the Contributed IP to the IPHC 110, including but not limited to, all invention disclosure documents, all documents sent to the USPTO or similar authority regarding inventions and claims, all draft patent applications, all filing or prosecution documents submitted to the patent offices, and all file wrappers. The IP source entity 100 will provide a limited waiver of privilege under a Community of Interest to allow the IPHC 110 to access the files of IP source entity's 110 attorneys who prosecuted the Contributed IP.
Grant Forwards: For a period of five (5) years (or other pre-determined number of years) from the Closing Date, the IP source entity 100 will provide the IPHC 110 with a royalty-free non-exclusive license (with rights to sub-license) for all patents that issue to or are otherwise assigned to the IP source entity 100 where such patents are blocking to the use of the Contributed IP. Alternatively, the IP source entity 100 agrees to contribute such issued or assigned IP on terms no less favorable than those herein.
Enforcement: The IPHC 110 may, but shall not be required to, prosecute any alleged infringement or threatened infringement of any Contributed IP of which it is aware or which is brought to its attention, including past infringement. The IPHC 110 shall act either in its own name or in the name of IP source entity 100, but in either event, at its own expense. If the IP source entity 100 notifies the IPHC 110 of potential infringement by third parties within the licensed field-of-use and the IPHC 110 elects not to prosecute the alleged infringement, then the IP source entity 100 shall have the right to act either in its own name or in the name of the IPHC 110 to pursue remedies to protect its rights as a licensee, but in either event, at its own expense. Regardless, IPHC shall be entitled to any damages recovered net of IP source entity 100's out-of-pocket enforcement expenses.

In some embodiments, the some or all of the Contributed IP is back licensed to the IP source entity 100 (the “Back-License Agreement”). In some embodiments, the obligation to form the Back-License Agreement is set out in the agreement that transfers the Contributed IP to the IPHC 110. In other embodiments, the Back-License Agreement is created as part of and/or at the same time the agreement that transfers the Contributed IP to the IPHC 110. The Back-License Agreement could also be created after the agreement that transfers the Contributed IP to the IPHC 110. The following are examples of contractual terms that may be included in the Back-License Agreement or to create the relevant entities' obligations to form the Back-License Agreement. They are provided as an example embodiment, and the invention should not be construed to require any or all of these provisions. Various combinations or additional terms may be used to create the Back-License Agreement or the obligation to create the Back-License Agreement.
License of Contributed IP from IPHC to IP source entity 100: The IPHC 110 (the “Licensor”) and IP source entity 100 (the “Licensee”) shall enter into a fixed-term, fixed-price, non-exclusive field-of-use license agreement (the “Back-License Agreement”).
Field of Use: The field-of-use of the Back-License Agreement shall be as provided in an exhibit that may be attached to the relevant agreement and shall be mutually agreed upon by the parties. Such field of use shall include IP source entity's 100 existing and planned business activities and reasonably related product or service expansions related thereto.
License Term: The term of the Back-License Agreement shall be as set forth in an exhibit that may be attached to the relevant agreement (the “Term”). The Term shall be a period that is mutually agreed upon by IP source entity 100 and IPHC 110.
License Payment Obligation: The Back-License Agreement shall be an unconditional and irrevocable “hell or high water” obligation of the IP source entity 100 with no rights of offset against amounts owed by IPHC 110. In addition, this payment obligation will be pari passu with all other senior unsecured indebtedness of IP source entity 100 and a default or acceleration under other secured or unsecured obligations of IP source entity 100 in excess of $[pre-defined amount] shall constitute a default under the Back-License Agreement. The Back-License Agreement can contain customary covenants and defaults consistent with other unsecured indebtedness of IP source entity 100.
Sub-License Rights: The Back-License Agreement shall prohibit IP source entity 100 from sub-licensing such rights other than to wholly-owned affiliates or other Controlled Subsidiaries, as such term is defined by the parties.
Events of Default: The following events shall, at Licensor's (IPHC 110) election, cause a default under the Back-License Agreement:
   Licensee's (IP source entity 100) failure to make a royalty payment and such failure is not cured within (5) business days;
   Licensee's breach of any other material term of the Back-License Agreement and failure to cure such breach within 60 days after receipt of notice;
   Any default under any unsecured indebtedness of Licensee; and
   Voluntary or involuntary liquidation, bankruptcy, receivership of Licensee.
In the event of the termination of the Back-License Agreement as a result of an event of default described above, the value (as “Licensor Damages”) of all unpaid royalty payments for all Contributed IP shall become immediately due and payable in full. Licensor Damages shall be calculated as the amount necessary for the Licensor to purchase on the damage payment date US Treasury securities sufficient to replicate (each, a “License Payment Defeasance”) each and every unpaid royalty payment. In addition, all rights and licenses granted to Licensee hereunder shall immediately be terminated and continued use by Licensee of the back-licensed IP after termination of the Back-License Agreement shall constitute patent infringement.
Patent Invalidity: In the event that a licensed patent is held to be invalid by a court beyond which no further appeal is available, this Back-License Agreement shall be amended to substitute other patent(s) or IP of equivalent pre-invalidity value, as chosen by Licensee.
Notices/Marking: The Licensee shall maintain all proprietary notices and shall mark the appropriate patent number or numbers on all licensed products to the extent reasonably possible.
Option Grant: Twelve months prior to the expiration of the Back-License Agreement, Licensee shall have the right to convert the Back-License Agreement to a fully paid-up non-exclusive field-of-use license effective upon the full payment of all scheduled royalties plus a fee equal to the lower of the fee determined by an independent appraisal and the then-current market value option fee (the “Option Fee”). The Option Fee shall be paid in cash or immediately available funds.
3^{rd} Party Outlicensing: IPHC 110 shall actively endeavor to commercialize and license its IP to unrelated 3^{rd} parties on an arm's-length, non-exclusive basis. Revenues therefrom are available on a pari passu basis with all other IPHC 110 revenue to Lender, Preferred Member and Common Member according to the priorities identified herein.
   Common Membership

In some embodiments, the IP source entity 100 may sell a portion of its 100% Common Membership Interest representing a percentage of the total Common Membership Interest for consideration to a third party investor. The IP source entity 100 and the third party investor would each become a “Common Member”. In some embodiments, upon the initial contribution of IP, the value of the Common Membership Interest may equal the entire appraised value of the contributed IP. In this embodiment, the Common Membership Interest(s) may represent residual ownership interests in the IPHC and may not pay any stated interest or dividends. Preferably, dividends on the Common Membership Interests are paid after all accrued and unpaid interest has been made current with respect to any senior debt, and all preference payments on any Preferred Membership Interests have been paid.

Preferred Membership Interest

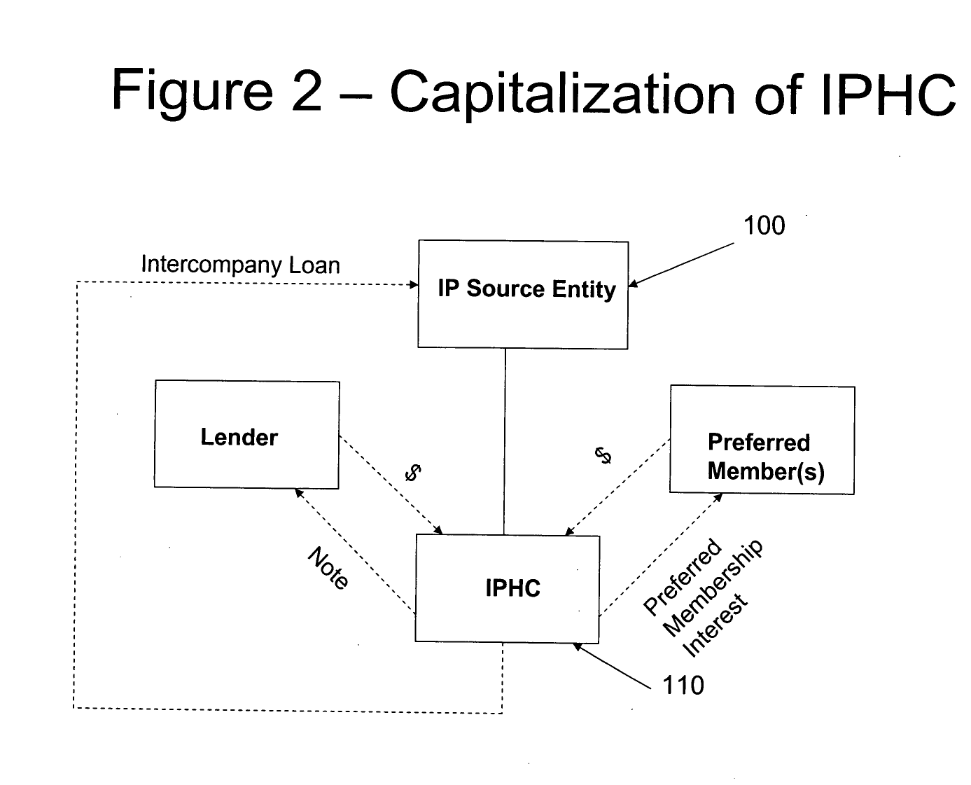

FIG. 2 illustrates one embodiment as to how the IPHC 110 is capitalized. In some embodiments, the IPHC sells a preferred membership interest to a third party investor (the “Preferred Member”) in exchange for an agreed upon capital contribution. Preferably, the Preferred Member(s) is entitled to returns based on the value of the IP held by IPHC 110 and the royalties thereon (the “Preferred Membership Interest”). In an alternative embodiment, the Preferred Membership Interest may be stratified into two or more classes (e.g., junior and senior preferred).

Preferably, the Preferred Membership Interest has a final maturity term and pays a periodic preference. In some embodiments, the periodic preference is calculated multiplying (i) the royalty rate as determined by the appraiser times (ii) a multiple (X) determined by mutual agreement of the parties to the transaction. For example, the final maturity term could be 10 years, the periodic preference could be quarterly and the multiple (X) could be 1. In some embodiments, the amount of preference may be re-calculated each time the IP held by the IPHC 110 is re-evaluated pursuant to periodic appraisals established by agreement. In some embodiments, the preference shall be cumulative, with accrued and unpaid preference amounts carrying over to the next payment period. Preferably, no payments or distributions may be made with respect to obligations junior to the Preferred Membership Interests, including but not limited to the Common Membership Interests until the Preferred Membership Interest has been made current. One embodiment provides the Preferred Membership Interest to be non-voting, but it is contemplated that a default situation may modify these rights.

In some embodiments, the Preferred Member may have the right but not the obligation to put the Preferred Membership Interest to the IPHC 110 at its then-current value at any time after a pre-defined period after the closing date if the periodic appraisal determines that the total value of the IP has dropped to or below a pre-defined percentage less than its original value. For example, the pre-defined period could be 5 years from the closing date and the pre-defined percentage could be 80%. In some embodiments, the IPHC in turn shall have the right but not the obligation to call the Preferred Membership Interest at its then-current value at any time after a pre-defined period after the closing date if the periodic appraisal shall have determined that the total value of the IP has risen to or above a pre-defined percentage of its original value. For example, the pre-defined period could be 5 years from the closing date and the pre-defined percentage could be 80%.

Contributions by Lending Institutions

In another embodiment, the IPHC borrows an agreed upon amount from a Lender pursuant to a senior credit facility (the “Credit Facility”) and incurs interest at pre-defined periods (e.g., quarterly) at a pre-defined rate (e.g., LIBOR plus [X] bps per annum). Preferably, the Credit Facility shall be a term financing and has a pre-defined final maturity date (e.g., 5 years from the date of borrowing). Preferably, the IPHC 110 makes periodic payments (e.g., quarterly) in arrears. In some embodiments, the IPHC 110 shall have no right to re-borrow funds that have been repaid. Preferably, the amount of principal amortization prior to maturity is mutually agreed upon between the IPHC 110 and the creditors (in this capacity, “Lender”). The loan can either be fixed rate or floating rate. Preferably, the base rate and spread (in the case of floating rate) or the interest rate (in the case of fixed rate) are mutually agreed in advance by the Lender and IPHC 110. Preferably, upon exercise of the call and/or put options with respect to the Preferred Membership Interest, the Facility will become immediately due and payable. In one embodiment of the invention, the Lender(s) has a first priority interest in the cash flows of the IPHC 110. In one embodiment, the Preferred Member(s) has a first priority interest in the IP owned by IPHC.

The following are examples of contractual terms that may be included in the agreement governing the loan extended to the IPHC 110 by the Lender. They are provided as an example embodiment, and the invention should not be construed to require any or all of these provisions. Various combinations or additional terms may be used to create the agreement governing this loan.
Events of Default: The following events shall, at Lender's election, cause a default under the Credit Facility:
   IPHC's 110 failure to pay interest when due;
   IPHC's 110 failure to pay principal when due and such failure is not cured within five (5) business days;
   IPHC's 110 breach of any other material term of the senior credit facility and failure to cure such breach within [60] days after receipt of notice;
   Any default under any unsecured indebtedness of IPHC 110; and
   Voluntary or involuntary liquidation, bankruptcy, receivership of IPHC 110.
In the event of a termination of the Senior Credit Facility as a result of an event of default described above, all amounts shall become due and payable immediately.
Prepayment: IPHC 110 may prepay Senior Credit Facility, subject to any applicable make-whole payment the parties agreed to on the Closing Date.
In the event that IPHC 110 exercises its Call Option with respect to the Preferred Membership Interest, or the Preferred Member exercises its Put Option, the Senior Credit Facility will become immediately due and payable.
Representations and Warranties: Any standard bank loan representations and warranties may be used.

In one embodiment of the invention, the IPHC lends all or some of the cumulative proceeds of its capitalization to the IP source entity 100. Preferably, the IPHC receives a note (e.g., an “Intercompany Note”) in that amount from IP source entity 100 evidencing its obligation to repay the loan, and the IP source entity 100 pays debt service on the loan periodically. In some embodiments, the IP source entity's obligation to pay the loan is unconditional. The debt service may or may not amortize the loan prior to maturity.

Cash Flow

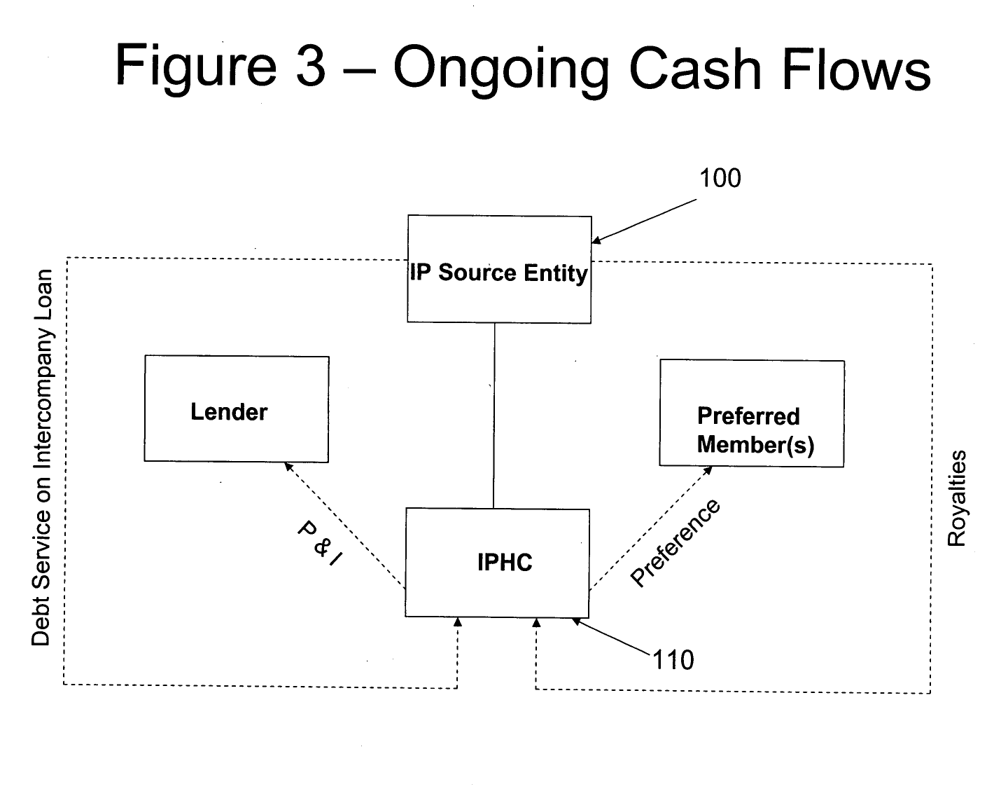

As illustrated in FIG. 3, one embodiment of the cash flow among the IP source entity 100, the IPHC 110, the Lender, and the Preferred Member(s) will now be described. Preferably, the IPHC 110 receives periodic debt service from IP source entity 100 on the intercompany loan. In some embodiments, the IPHC 110 also receives royalties from IP source entity 100 for the use of the IP owned by the IPHC 110. Furthermore, the IPHC 110 preferably receives royalties and/or other consideration if IP rights have been licensed or otherwise transferred to third parties.

In some embodiments, the IPHC 110 pays period debt service to the Lender. Preferably, the IPHC also pays a periodic preference to the Preferred Member to the extent cash is available. If sufficient cash is not available, some embodiments provide for the obligation to be carried over to future periods until cash is available to pay all current and past amounts owing.

In some embodiments of the invention, the IP source entity 100 is responsible for paying off the loan made by the IPHC 110 to the IP source entity 100. In this embodiment, the IPHC 110 is responsible for paying the Lender(s)/investor(s). In some embodiments the IPHC 110 retires the Preferred Membership Interest.

Common Interest

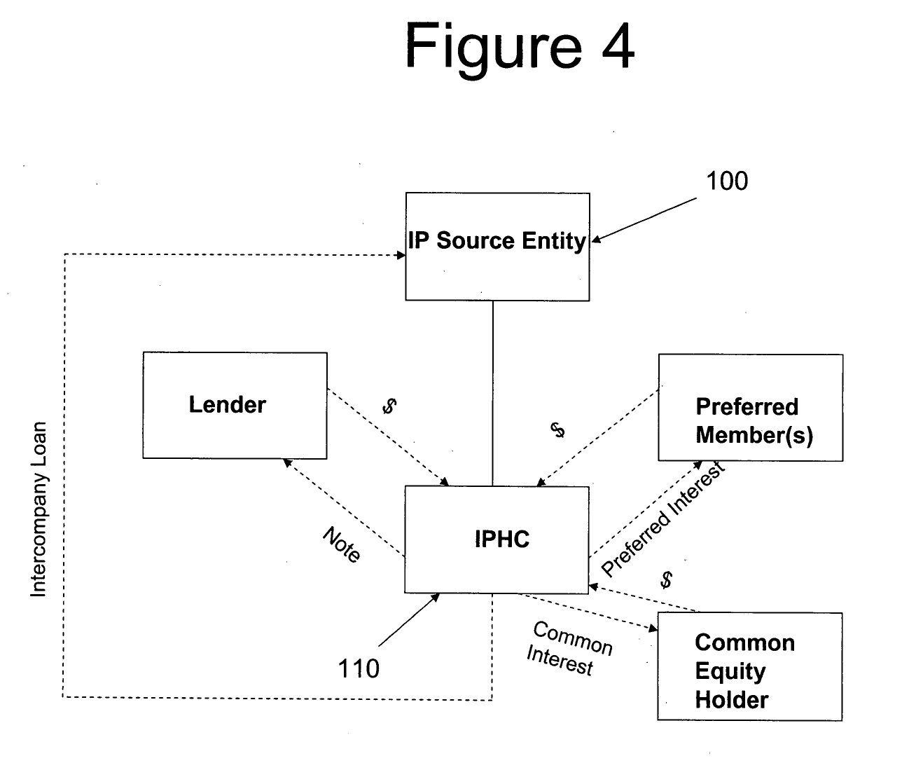

An alternative embodiment of the invention is depicted in FIG. 4. In addition to providing for issuance of debt and Preferred Membership Interest, this embodiment provides for the issuance of a junior, common equity strip. This embodiment may also provide a plurality of sub-classes of preferred. In this embodiment, the common interest may be privately negotiated and/or sold, or it may be issued as a type of “IP” tracking stock in public markets. In one embodiment common equity in the IPHC is tradable, whether initially issued in private markets, public capital markets, or any other suitable manner, and whether such common equity represents a majority ownership or control position in the IPHC 110, in any case, third party trading of such common equity implies a market value for the IPHC and by extension for the IP held thereby. Preferably, information about pricing and trading volume of the common interest would be calculated and communicated in real time via computers and computer networks, such as through a private online database service. In some embodiments, the common equity has a pure residual interest in the assets and cash flows of the IPHC 110. Preferably, the common interest is tradable, whether private, public, or any other form.

Embodiments that include alternative security offerings, such as the embodiment of FIG. 4, offer additional flexibility in designing structural solutions to IPHC 110 and investor/lender problems and objectives. Furthermore, embodiments of this type provide security interests for those investors seeking investments having risk and return profiles closely tied to IP risks (i.e. a more “pure” IP risk). Furthermore, embodiments that allow common interest in the IPHC to be widely distributed and/or freely traded provide market valuations of the IPHC's. Advantageously, this provides a means to determine IP values independent of any one appraiser's subjective assessments.

Valuation of IP

In some embodiments of the invention, on a pre-defined periodic basis (e.g., annual), a third party appraisal may be performed to investigate the value of the IP held by IPHC and the appropriate royalty rates for the IP. The appraisal value of the IP can provide helpful information in forming the relationships discussed above. The current value of the IP portfolio may be relevant to the IPHC 110 asset management and/or borrowing programs.

In some embodiments, the traditional valuation methodologies (e.g., discounted cash flows, relief from royalty, etc.) are used. In other embodiments, statistical valuation methodologies are used. For example, one such statistical valuation methodology is described in U.S. patent application Ser. No. 10/397,053, filed on Mar. 25, 2003 and published on Jan. 15, 2004 as US Publication No. 2004/0010393 A1, the entire contents of which is incorporated herein by reference. Another example of a statistical patent evaluation method is described in U.S. Pat. No. 6,556,992 filed on Sep. 14, 2000, which is also incorporated herein by reference. It is contemplated that other suitable appraisal methods may also be used. Preferably, which appraisal method is used is within the discretion of the appraiser. In some embodiments, the relevant parties have previously agreed that preference rates are reset based on the opinion of value and reasonable royalty rates certified by the appraiser. In some embodiments, the IP and related royalty rates may be re-assessed periodically, but in any event, it is preferable that assessments are conducted no less frequently than annually. However, it is contemplated that re-assessment could take place less frequently than annually.

As discussed above, there are a number of different approaches that can be used to determine the fair market value of IP assets. A method that combines an estimate of the value of an IP asset with an assessment of the impact on the value of the selling business of utilizing that IP asset may be provided in certain embodiments of the present invention. This method comprises receiving information related to at least one IP asset, calculating a value of the at least one IP asset using a first valuation algorithm, selecting a second valuation algorithm having a plurality of inputs, inputting the value of at least one IP asset into the second valuation algorithm, inputting at least one additional piece of information required by the second valuation algorithm, and calculating the change in value to the owner of the IP asset using the second valuation algorithm. The method may further comprise inputting an identifier indicative of a utility of the IP asset by selecting from a list including such options as: “new product category,” “improvement on an existing product,” “a new process,” “an improvement on an existing process,” and “regulatory compliance.” The method may further comprise selecting a first valuation algorithm from a plurality of valuation algorithms by selecting a first valuation algorithm particular to the type of utility associated with the IP asset. The method may further comprise receiving information on the financial characteristics of the owner not directly related to the IP asset.

Typical information used for the valuation method of this embodiment includes, but is not limited to: current and projected future revenues and costs of the goods covered by the IP asset, cost savings attributable to an invention covered by an IP asset, the book value of the business activities associated with the IP asset, and ongoing expenditures for marketing, research and development. As will be appreciated, it can be difficult to calculate a value for an IP asset that is not associated with any current or ongoing revenues or costs.

The particular valuation algorithm used will determine what information must be obtained regarding the IP asset and entered for the valuation to be completed. For example, when making a valuation for a patent covering an environmental control invention that permits a business to continue operation under regulatory requirements, the evaluation should take into consideration the ongoing revenue generated by the continuation of the business. In addition to financial information, information such as the remaining life of the patent may be used by the first valuation algorithm. In some embodiments, after the appropriate first valuation algorithm has been determined for each IP asset within a portfolio, the current value of the portfolio is determined using the appropriate algorithms.

Analysis and Optimization of Corporate Structure

One embodiment of the current invention provides computer models, programs and algorithms for optimizing and implementing embodiments of the above financing structure. Preferably, these models will include, but are not limited to, Microsoft Excel worksheets which track, calculate and optimize cash flows, returns and rates, given the deal-specific constraints. In one embodiment, this process is complex and non-linear, and it is therefore anticipated to require an iterative approach to solution and optimization, both within the model and at a higher level of abstraction, as the parties to the transaction are expected to engage in an iterative negotiation and optimization of the structure. To facilitate the former iteration, computer based models are preferable. To facilitate the iteration and negotiation among the parties, it is anticipated that email and other file sharing tools and techniques may be used. In one embodiment, ongoing administration of the mutually agreed financing structures will be monitored and communicated via computers and computer networks.

The general elements of one embodiment of the invention include computer based tools including but not limited to Microsoft Excel models of the entities involved in the financings described above, macros and programs which accept the stated objectives of IP owners, borrowers, lenders, preferred and common investors and optimize the economics of the financing structure given the constraints required by the various parties. In one embodiment, the original design of the financing structure as well as the ongoing administration of the plurality of cash flows among the various parties will be tracked by custom-designed computer programs and algorithms, and information monitored and calculated thereby will be communicated via electronic communication devices such as modems, intranets, the internet and other communication systems determined to be optimal in light of the facts and circumstances specific to any given financing.

In one embodiment, these tools and techniques will be used to monitor and optimize: intellectual property being contributed to the IPHC 110; work by third party appraisers to value the IP and determining reasonable royalty rates based on that valuation; the issuance by the IPHC 110 of fixed or floating rate debt, preferred and/or common equity based solely on the IP and associated cash flows from commercial exploitation thereof; determination of the debt rate based on the creditworthiness of the IPHC 110 and not the IP source entity 100; determination of the preference based on the IP value and related royalty rates, ownership of all or a portion of the residual interest in the assets and cash flows of the IPHC 110 by the common equity holder, if any; ongoing periodic valuation of the IP and royalty rates by a mutually agreed method, including but not limited to standard discounted cash flow analysis by a qualified appraiser, use of statistically based valuation methodologies such as those described in US Patent Application publication 2004/0010393 (or any other suitable valuation techniques described herein or elsewhere), with preference rates set at mutually agreed multiples or portions thereof; the ability for the issuer, lender and investors to hedge their exposure via simultaneous puts and calls.

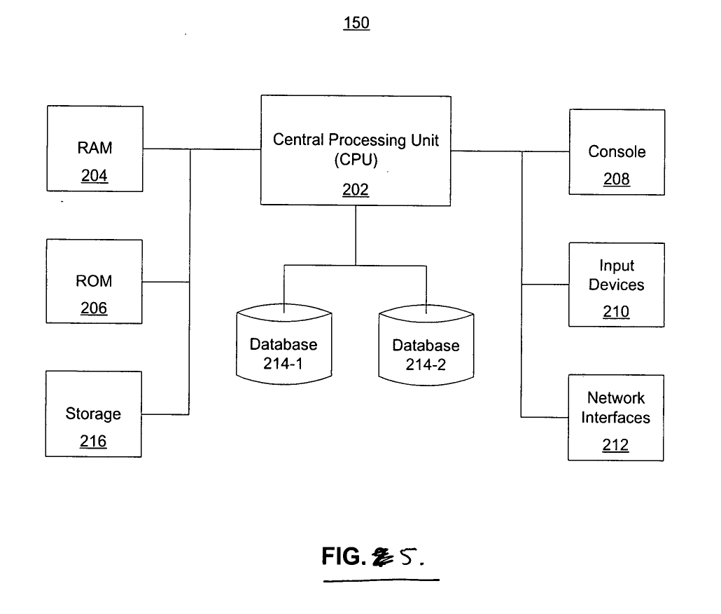

Some or all of these optimization and analysis tasks may be performed by a transaction workstation 150, as depicted in FIG. 5. In some embodiments, the transaction work station 150 may include a central processing unit (CPU) 202, a random access memory (RAM) 204, a read-only memory (ROM) 206, a storage 216, a console 208, input devices 210, network interfaces 212, and databases 214-1 and 214-2. It is understood that the type and number of listed devices are exemplary only and not intended to be limiting, the number of listed devices may be varied and other devices may be added without departing the principle and scope of the present invention.

CPU 202 may execute sequences of computer program instructions, more specifically, sequences of computer program instructions that cause CPU 202 to perform various analysis and/or optimization of the above described transaction(s) consistent with the present invention. The computer program instructions may be loaded into RAM 204 for execution by CPU 202 from a read-only memory (ROM). Storage 216 may be any mass storage provided to store any type of information the CPU 202 may need to perform operations. Storage 216 may be one or more hard disk devices, optical disk devices, or other storage devices to provide storage space for security gateway.

Console 208 may provide a graphic user interface (GUI) to display information to users of transaction workstation 150. Console 208 may be any type of computer display devices or computer monitors. Input devices 210 may be provided for the users to input information into transaction workstation 150. Input devices 210 may include a keyboard, a mouse, or other optical or wireless computer input devices. Further, network interfaces 212 may provide communication connections such that transaction workstation 150 may be accessed remotely through computer networks.

Databases 214-1 and 214-2 may contain data and any information related to the above described transactions. Databases 214-1 and 214-2 may also include analyzing tools for analyze the information in the databases. CPU 202 may use databases 214-1 and 214-2 to estimate and/or calculate variables relevant to the above described transaction(s). For example, NPV, risk probabilities, etc can be calculated.

The skilled artisan would understand that not all calculations, analysis and/or optimization require the use of computers. Some of the above described steps can be performed by humans or other types of machines. In some circumstances, the tasks presented above may be more effectively performed by humans or other types of machines.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. A method for financing an intellectual property holding comprising:
Transferring IP assets from an IP source entity to a separate IP holding company;
Transferring back to the IP source entity at least a portion of the ownership of the IP holding company;
Transferring at least one investment interest from the IP holding company to at least one 3^{rd} party investor; and
Transferring capital from the at least one 3^{rd} party investor to the IP holding company.

2. The method of claim 1 wherein the IP holding company back licenses some or all of the IP assets to the IP source entity.

3. The method of claim 1 wherein the IP holding company loans the capital to the IP source entity and the IP holding company receives an intercompany note from the IP source entity in return.

4. The method of claim 1 wherein the investment interest is a preferred membership interest.

5. The method of claim 1 wherein the investment interest is a common interest.

6. The method of claim 1 wherein the investment interest is a lender interest.

7. The method of claim 1 wherein there is more than one type of investment interest;

8. The method of claim 7 wherein the investment interests have different rights and/or obligations;

9. The method of claim 8 wherein the investment interests include a common interest and/or a preferred interest and/or a lender interest.
